(19) United States
(12) Patent Application Publication
(10) Pub. No.: US 2002/0093622 A1
(43) Pub. Date: Jul. 18, 2002

(54) Flip-up eyewear

(76) Inventor: Brian Tostado, Santa Ana, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/035,989

(22) Filed: Dec. 24, 2001

Related U.S. Application Data
(60) Provisional application No. 60/257,667, filed on Dec. 22, 2000.

(51) Int. Cl. G02C 7/08; G02C 9/02

(52) U.S. Cl. 351/57; 351/58; 351/59

(57) ABSTRACT

A flip-up eyewear device includes a primary frame that is adapted to fit upon a wearer's face and a secondary frame that is rotatably mounted to the primary frame. A pair of hinges connect the primary and flip-up frames. The primary frame has a pair of upper rims, each having a set-back portion. A hinge is mounted onto a front surface of the set-back portion. The hinge operates between an upper rim of the primary frame and an upper rim of the flip-up frame and fits generally within the set-back portion so that the hinge is substantially hidden from view when viewed from the front of the eyewear. The set-back mounting allows the hinge to be large enough to contain a biasing spring without the hinge extending substantially above the frame or causing the flip-up frame to be positioned excessively far from the primary frame. Magnet pairs engage each other when the flip-up frame is in the DOWN position in order to hold the frame in place relative to the primary frame. The spring-loaded hinges are adapted so that when the hold of the magnets is disrupted, the flip-up frame is urged towards the UP position and is held in the UP position. As such, the flip-up eyewear is aesthetically pleasing, is not bulky and cumbersome, and is easy to operate.

### PRIORITY INFORMATION

This application is based on and claims priority to U.S. Provisional Application No. 60/257,667, filed Dec. 22, 2000, the entire contents of which are hereby expressly incorporated by reference.

### BACKGROUND OF THE INVENTION

1. Field of the Invention

This invention relates to eyewear, and relates more particularly to eyewear having a flip-up lens.

2. Description of the Related Art

Eyewear is worn for a number of reasons, such as correcting a person's vision and protecting a person's eyes from the bothersome and harmful glare of the sun. Traditionally, sunglasses include tinted lenses that ease the strain on a wearer's eyes when in the sun. Persons wearing sunglasses often find themselves moving through both areas of direct sunlight and areas of shadows. Sunglasses are desirable when a person is in direct sunlight, but are usually undesirable when in the shadows. As a result, sunglass wearers may find themselves repeatedly removing and replacing their sunglasses. This is problematic because such repeated removal is inconvenient and bothersome.

Flip-up sunglasses have been provided so that users may retain the eyewear in place, yet flip the darkened lens out of the way when not desired. Typically, flip-up sunglasses include a hinge that allows the user to manually rotate the tinted lens out of the user's line of vision and secure the lens in place in an upward position by using a detent, mechanical clip, or the like. Such flip-up sunglasses allow a user to adjust to the particular viewing and lighting conditions without completely removing their eyewear.

Certain features of flip-up sunglasses, however, have detracted from their popularity and desirability. For example, the hinge of the flip-up sunglasses is typically prominently visible. Also, the hinge is often bulky and extends upwardly or outwardly an excessive distance from the eyewear frame. This creates a cumbersome and bulky look that many wearers find undesirable. Additionally, manually flipping the sunglasses into place and engaging a detent can be cumbersome and irritating. For example, the force required to engage or disengage a detent or clip may cause the eyewear frame to shift in position on the person's face. Thus, the user must readjust the fit of the eyewear on his face each time the lens-flipping operation is performed. Additionally, such detents can be unreliable and may not provide a very good fit or grasp of the sunglasses in either the flipped-UP or the DOWN position.

### SUMMARY OF THE INVENTION

Accordingly, there is a need in the art for a flip-up eyewear device having a construction wherein the hinges are substantially hidden from view and the mode of operation enables secure holding of the flip-up lens in either the DOWN or UP position while requiring relatively little effort by the user.

The present invention provides a flip-up eyewear device wherein a flip-up frame member is connected by a spring-loaded hinge to a primary frame member, which fits upon a wearer's face. The spring-loaded hinge operates between the flip-up frame and the primary frame. Magnets operating between the flip-up frame and primary frame releaseably retain the flip-up frame in the DOWN position relative to the primary frame. The spring-loaded hinge automatically lifts and holds the flip-up frame in the UP position when the engagement between the magnets is disrupted by the user.

A set-back portion is provided in an upper rim of the primary frame. The hinge is mounted within the set-back portion so that the hinge is substantially hidden from view when the eyewear is viewed from the front. Additionally, providing the hinge in the set-back portion allows the flip-up frame to be positioned very close to the primary frame, thus decreasing the bulk of the eyewear.

In accordance with one aspect, an eyewear system is provided for positioning optical lenses in a wearer's field of vision. A primary frame of the system comprises a rim having an upper rim portion. The rim comprises a metallic wire. The upper rim comprises a set-back portion. The rim in the set-back portion extends backwardly and includes a forwardly facing mounting surface. A flip-up frame of the eyewear system comprises a rim having an upper rim portion and having a lens secured within the rim. The rim comprises a metallic wire. At least one hinge is connected to a back side of the flip-up upper rim and a front side of the primary upper rim mounting surface. The hinge is positioned between the primary and secondary frames. The hinge and frames are configured so that the flip-up frame rotates relative to the primary frame between an up position wherein the flip-up frame is generally above the primary frame, and a down position wherein the flip-up frame is generally in front of the primary frame. A stop is connected to the primary frame and is adapted to engage a stop connected to the flip-up frame in a manner so as to prevent the flip-up frame from rotating in a first rotational direction beyond the down position.

In accordance with another aspect, the present invention provides an eyewear system for positioning optical lenses in a wearer's field of vision. The system includes a first frame comprising a recessed portion extending rearwardly and having a forwardly-facing mount surface, and a second frame configured to support a lens therewithin. A hinge is connected to a back side of the second frame and the forwardly-facing mount surface of the first frame so as to be between the first and second frames. The hinge and frames are configured so that the second frame rotates relative to the first frame between an up position wherein the second frame is generally above the first frame, and a down position wherein the second frame is generally in front of the first frame.

Further aspects, features and advantages of this invention will become apparent from the detailed description of the preferred embodiment which follows.

### BRIEF DESCRIPTION OF THE DRAWINGS

FIG. 1 is a perspective view of the eyewear of the present invention, with the frame in the DOWN position.

FIG. 2 is a top view of the eyewear of FIG. 1.

FIG. 3 is a front view of the eyewear of FIG. 1.

FIG. 4 shows the eyewear of FIG. 3 with the flip-up frame in an UP position.

FIG. 5 is a side view of the eyewear of FIG. 1.

FIG. 6 shows the eyewear of FIG. 5 with the flip-up frame in an UP position.

FIG. 7 is a back view of the eyewear of FIG. 1.

FIG. 8 is a bottom plan view of the eyewear of FIG. 1, showing the flip-up frame in an UP position.

### DETAILED DESCRIPTION OF THE PREFERRED EMBODIMENT

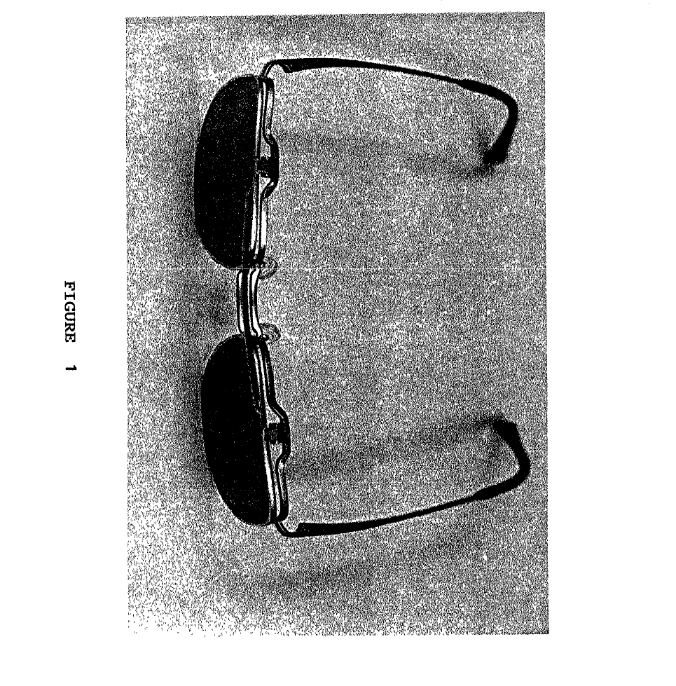

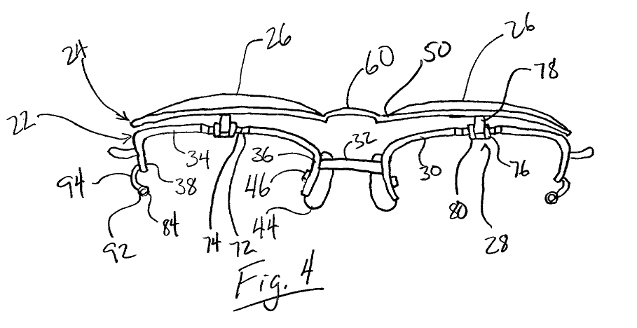

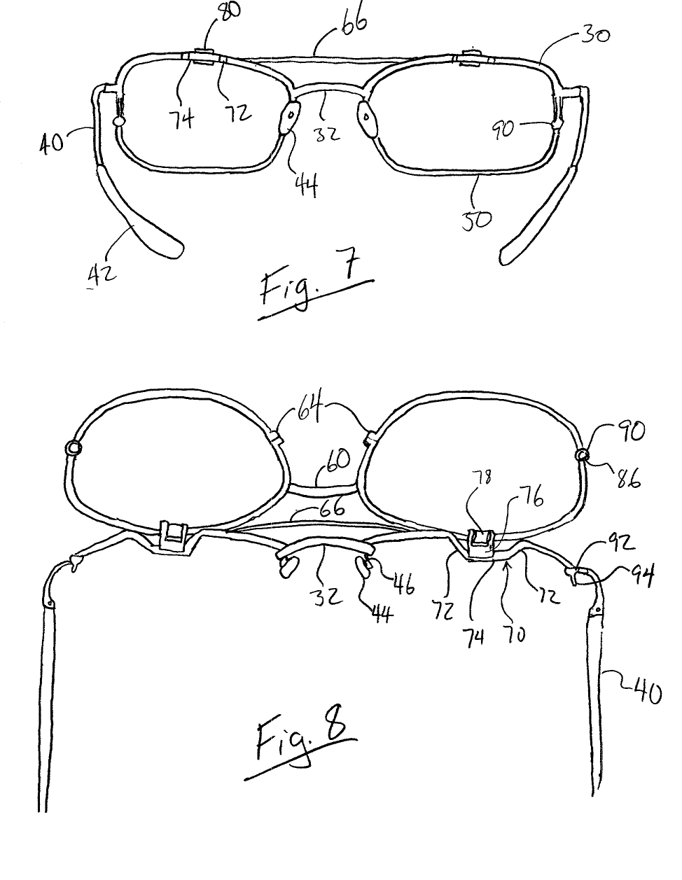

With reference first to FIG. 1, a flip-up eyewear device 20 includes a primary frame 22 and a flip-up frame 24. The primary frame 22 is configured to fit comfortably on a user's face; the flip-up frame 24 includes lenses 26 and is attached by hinges 28 to the primary frame 22. The flip-up frame 24 can be rotated relative to the primary frame 22 in order to selectively move the lenses 26 into and out of the wearer's line of sight. The flip-up frame 24 is rotatable between a DOWN position, shown in FIGS. 1, 2, 3, 5 and 7, and an UP position, shown in FIGS. 4, 6 and 8. The flip-up frame lenses 26 are disposed within the wearer's line of sight when in the DOWN position, but are substantially removed from the wearer's direct line of sight when in the UP position.

In the illustrated embodiment, the primary frame 22 comprises two metallic rims 30 connected to each other by a bridge 32. Each of the rims 30 preferably comprises an upper rim portion 34, an inside rim portion 36, and an outside rim portion 38. A front surface of the frame 22 faces away from a wearer, and a back surface of the frame faces the wearer. The illustrated primary rim 22 is of the “half-rim” style.

Temple members 40 connect to each of the outside rims 38, and an earpiece 42 of each temple member 40 helps to secure the eyewear 20 in place on the wearer. Silicon nosepads 44 are provided to support the weight of the eyewear 20. Each silicon pad 44 is connected to its respective inside rim 36 through a pad wire 46. The pad wire 46 is deformable so that the position of the nose pads 44 can be adjusted by the wearer.

The flip-up frame 24 also comprises two metallic rims 50. The flip-up rims 50 in the illustrated embodiment are of the full-rim style, having an upper rim portion 52, outside rim portion 54, bottom rim portion 56, and inside rim portion 58. The rims 50 are connected to each other by a bridge 60. A lens 26 is fit within each rim 50. The lenses 26 are secured in place within the rims 50 by rim locks 64 (see FIG. 8), which allow each rim 50 to be tightened about the lens 26. Lenses 26 of any known type or material, such as glass or polycarbonate lenses, can be used.

In an additional embodiment, a decorative brow bar 66 extends between the rims 50 for aesthetic purposes. It is to be understood that any manner of decorative structures can be included on the flip-up frame 24 for decorative purposes.

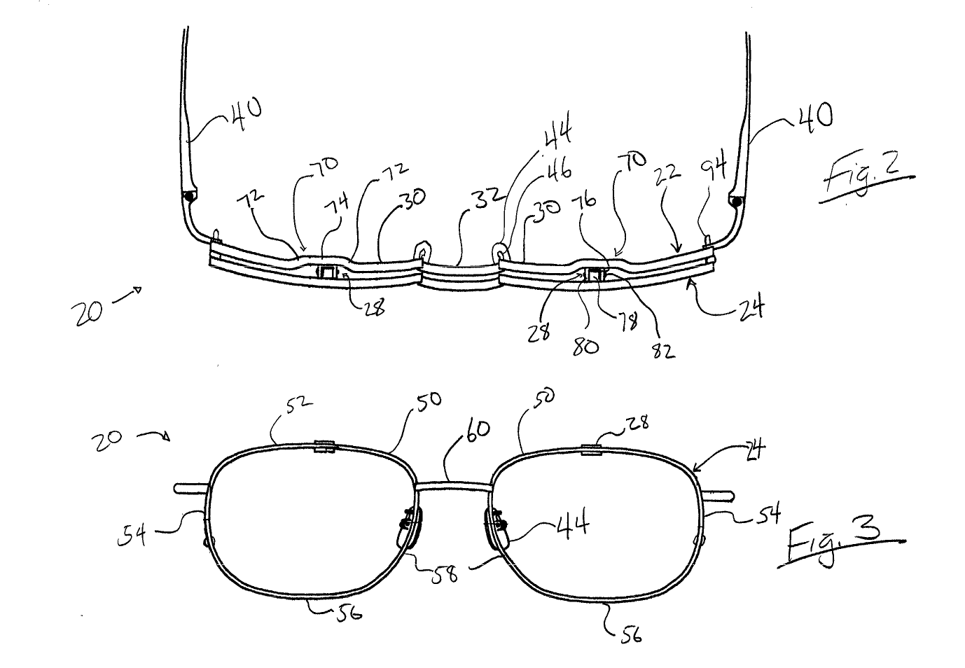

As seen in FIG. 2, the upper rims 52 of the flip-up frame 24 are gently curved in order to accommodate a curving lens portion 26, as is often desired in optical wear. The upper rims 34 of the primary frame 22 are spaced a short distance from the flip-up frame upper rims 52 and generally follow the curvature of the flip-up frame upper rims 52. However, each primary frame upper rim 34 has a set-back portion 70 that extends generally toward the wearer. In each set-back portion 70, the upper rim 34 has a pair of transition sections 72 in which the rim bends and extends toward the wearer. A substantially straight mounting portion 74 extends between the transition portions 72.

A primary hinge mount 76 is attached to the front surface of the rims 30 in each mounting portion 74. A corresponding secondary hinge mount 78 is attached to the flip-up frame upper rim 52. The primary and secondary hinge mounts 76, 78 engage each other to form a hinge body 80. As seen also in FIGS. 3 and 6, the hinge body 80 is disposed generally between the primary and flip-up frame upper rims 34, 52 so that the hinge body 80 is substantially hidden from view when viewed from the front with the flip-up frame DOWN (see FIG. 3).

The hinge mounts 76, 78 are preferably connected by a screw, bolt or other typical hinge connector that acts as a hinge pin 82. A spring steel wire is wound about the hinge pin 82 within the hinge body 80 in order to bias the flip-up frame toward the UP position. The body 80 is sized and configured to accommodate the spring wire.

The above-described configuration is especially advantageous for eyewear styles such as the illustrated “wireframe” style wherein the hinge 28 is formed separately from the frames 22, 24 and then attached to the frames 22, 24. For instance, in the illustrated embodiment, each primary frame rim 30 comprises a molded metallic “wire” that is deformed and bent by using a mold, die or the like in order to attain the desired rim shape, including the set-back portion 70. The hinge 28, bridge 60, etc. are then attached by a weld, solder, etc. The continuity of the rim material is not disrupted to interpose a hinge pin or the like; therefore, the set-back design enables the metal rim to retain its integrity and strength.

The illustrated flip-up frame 24 accommodates lenses having various curvatures. For example, it accomodates “8 base” lenses as well as “6 base” lenses. As known in the art, “8 base” lenses have a greater base curvature than “6 base” lenses, and are more typically used in sunglasses. It is to be understood that an advantage of the present invention is that lenses of various base curvatures can be used without disrupting the general correspondence of curvature between the flip-up frame and primary frame and without interfering with the operation of the hinges.

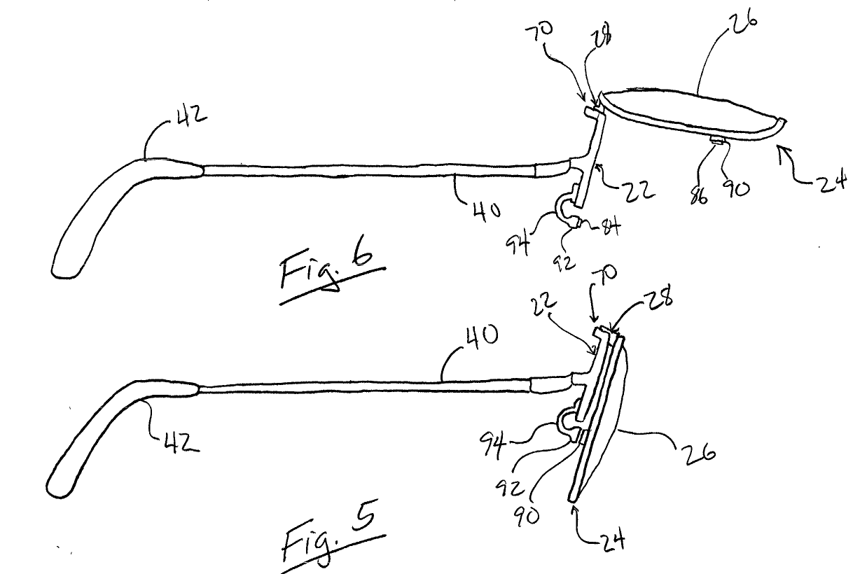

With particular reference to FIGS. 5-8, a pair of magnets 84 are connected to the primary frame 22, and a corresponding pair of magnets 86 are connected to the flip-up frame 24. The primary frame magnets 84 and flip-up frame magnets 86 are configured to cooperate with one another when the flip-up frame 24 is in the DOWN position. The magnets 84, 86 preferably are selected so as to produce an attractive force, when engaged, that overcomes the force exerted by the spring-loaded hinges 28. As such, the magnets 84, 86 releasably hold the flip-up frame 24 in the DOWN position when engaged. The primary frame magnets 84 also function as stops to prevent the flip-up frame 24 from rotating beyond the DOWN position relative to the primary frame 22.

Each flip-up frame magnet 86 is disposed within a flip-up frame magnet pad 90, which is positioned on the outside rim 54 of the flip-up frame 24. The flip-up frame magnet pad 90 is welded or soldered onto the flip-up frame 24. In some embodiments, the flip-up frame magnet pad 90 can be formed integrally with the flip-up frame. Each primary frame magnet 84 is disposed within a primary frame magnet pad 92, which is connected by a magnet pad arm 94 to the outside rim 38 of the primary frame 22.

The magnet pad arms 94 are deformable by applying pressure with a user's finger or by using appropriate optical tools, such as optical pliers, in order to adjust the position of each primary magnet pad 94. This enables each primary magnet pad 84 to be adjusted to a position that will maximize contact with the corresponding flip-up magnet pad 86, thus compensating for any stretching or bending of the primary frame 22 and flip-up frame 24 relative to one another. Such stretching and/or bending may be expected to occur over time and use with certain types of eyewear.

In operation, the engaged magnets 84, 86 hold the flip-up frame 24 in the DOWN position. In order to move the frame to the UP position, a wearer simply applies enough force to the flip-up frame 24 to disrupt the magnetic engagement between the magnets 84, 86. Once the magnetic engagement is disrupted, the spring-loaded hinge 28 automatically urges the flip-up frame 24 to the UP position.

Since the force required to disrupt the magnetic bond is not very great, moving the flip-up frame 24 from the DOWN position to the UP position can be performed without substantially disrupting positioning of the eyewear 20 on the wearer's face. Similarly, the flip-up frame 24 can be moved from the UP position to the DOWN position by simply being pushed into place. Since the spring force is generally constant, pushing the flip-up frame 24 from UP to DOWN is a fluid motion without the sudden or jerking movement that would result from releasing the flip-up frame from a detent or a mechanical clip. Thus, the flip-up frame 24 can be moved between the UP and DOWN positions without disrupting the fit of the eyewear 20 on the wearer's face.

With reference again to FIGS. 3 and 4, the primary frame 22 and flip-up frame 24 are preferably shaped and adapted to generally correspond with each other. For example, as discussed above, the upper rims 52, 34 of the flip-up and primary frames 22, 24 generally correspond to each other in their gently curved shapes. Similarly, the bridges 32, 60 of the flip-up and primary frames 22, 24, as shown in FIG. 2, are shaped generally similar to each other. With reference next to FIGS. 3 and 4, the rims 50 and bridge 60 of the flip-up frame 24 have substantially the same frontal profile as the half-rims 30 and bridge 32 of the primary frame 22. Thus, when the flip-up frame 24 is in the DOWN position, the rims 30 and bridge 32 of the primary frame 22 are substantially hidden from view from the front, as illustrated by FIG. 3. Similarly, since the hinge body 80 is substantially positioned in the set-back 70 between the flip-up and primary frame upper rims 52, 34, the hinge 28 is substantially hidden from view, and the aesthetic appearance of the eyewear 20 is pleasing rather than distracting. The set-back mounting of the hinge 28 also allows the flip-up frame 24 to be mounted in close proximity to the primary frame 22. This further allows the eyewear 20 to avoid the cumbersome, bulky look that is often the case with flip-up eyewear.

The illustrated embodiment presents one embodiment of an eyewear device 20 including aspects of the present invention. It should be noted that eyewear comes in various shapes and styles, which styles may or may not include all of the features disclosed and discussed above. For example, some eyewear embodiments may not include earpieces or nosepads. Accordingly, it is to be understood that several embodiments embodying all or some of the aspects described above can be employed.

In an additional embodiment, the primary frame can have a nonmetal injection-molded construction wherein the rims of the frame are formed substantially unitarily. In this embodiment, the setbacks may be formed by creating a pair of depressions in the primary frame that are shaped and configured so as to accommodate spring hinges. Similarly, the magnet pads may be formed as part of the extruded or molded rim.

In another additional embodiment, it may be desired to include a prescription lens within the primary frame and a tinted lens within the flip-up frame. In such an embodiment, a groove is added to the inner surface of the primary rim in order to accommodate the lens in a manner known in the art. Additionally, a wire may be used to encircle and hold the lens, while the primary frame is still configured in the illustrated half-rim arrangement. Additionally, a full-rim arrangement, similar to that of the flip-up frame, can be employed.

In further additional embodiments, magnet pads 90, 92 can be arranged in various locations. For example, in one additional embodiment, the corresponding magnet pads 90, 92 are installed adjacent the bridge so that a magnet extends rearwardly from the flip-up frame bridge 60 and a complementary magnet extends forwardly from the primary frame bridge 32. In this manner, the magnets are substantially hidden from view from the front, yet engage each other when the flip-up frame is in the DOWN position.

In yet an additional embodiment, each of the frames can be die-cut out of a sheet of titanium, then bent into shape through use of another die. In this manner, each frame has a substantially unitary structure, which provides additional strength. The unitary construction reduces the need for welds or soldering and allows the frame to be made thinner and lighter. Cutting the frame from a metallic sheet also allows the frame thickness to be tightly controlled.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. An eyewear system for positioning optical lenses in a wearer's field of vision, comprising:
a primary frame comprising a rim having an upper rim portion, the rim comprising a metallic wire, the upper rim comprising a set-back portion, wherein the rim in the set-back portion extends backwardly and includes a forwardly facing mounting surface;
a flip-up frame comprising a rim having an upper rim portion and having a lens secured within the rim, the rim comprising a metallic wire;
at least one hinge connected to a back side of the flip-up upper rim and a front side of the primary upper rim mounting surface, the hinge being positioned between the primary and secondary frames, the hinge and frames configured so that the flip-up frame rotates relative to the primary frame between an up position wherein the flip-up frame is generally above the primary frame, and a down position wherein the flip-up frame is generally in front of the primary frame; and
a stop connected to the primary frame and adapted to engage a stop connected to the flip-up frame in a manner so as to prevent the flip-up frame from rotating in a first rotational direction beyond the down position.

2. The eyewear system of claim 1, wherein the hinge is spring-loaded, and the hinge is configured to bias the flip-up frame to the up position.

3. The eyewear system of claim 2, wherein the stops comprise magnets, and the magnets are adapted to overcome the biasing force of the spring hinge.

4. The eyewear system of claim 3, wherein the primary frame stop is connected to the primary frame through a deformable member.

5. The eyewear system of claim 1, wherein the primary frame has a front profile and the flip-up frame has a front profile, and the primary frame front profile corresponds to at least a portion of the flip-up frame front profile.

6. The eyewear system of claim 1, wherein the hinge is substantially hidden from view from the front by the flip-up frame when the flip-up frame is in the closed position.

7. The eyewear system of claim 1, wherein the primary frame comprises two rims that are connected by a bridge portion.

8. The eyewear system of claim 7, wherein the rims and bridge portions are unitarily formed.

9. The eyewear system of claim 1, wherein the set-back portion comprises a rearwardly-directed transition portion on either side of the mounting surface.

10. An eyewear system for positioning optical lenses in a wearer's field of vision, comprising:
a first frame comprising a recessed portion extending rearwardly and having a forwardly-facing mount surface;
a second frame configured to support a lens therewithin; and
a hinge connected to a back side of the second frame and the forwardly-facing mount surface of the first frame so as to be between the first and second frames, the hinge and frames configured so that the second frame rotates relative to the first frame between an up position wherein the second frame is generally above the first frame, and a down position wherein the second frame is generally in front of the first frame.

11. The eyewear system of claim 10 additionally comprising a stop connected to the first frame and being configured to engage a corresponding stop connected to the second frame so as to prevent the second frame from rotating in a first rotational direction beyond the down position.

12. The eyewear system of claim 10, wherein the hinge is substantially hidden from view behind the second frame when the eyewear system is viewed from the front side.

13. The eyewear system of claim 10, wherein the primary frame comprises two recessed portions, each recessed portion having a mount surface, and the mount surfaces are substantially coplanar.

14. The eyewear system of claim 13, wherein the primary frame comprises a right rim and a left rim, and one recess is disposed in the right rim, and one recess is disposed in the left rim.

15. The eyewear system of claim 10, wherein the hinge is spring-loaded so as to bias the second frame to the up position.
